(19) United States
(12) Patent Application Publication
(10) Pub. No.: US 2019/0132558 A1
(43) Pub. Date: May 2, 2019

(54) IP CAMERA TRIGGERING SYSTEMS AND METHODS

(71) Applicant: Novolink, Inc., Walnut, CA (US)

(72) Inventor: Fang (Frank) Lu, Walnut, CA (US)

(21) Appl. No.: 15/799,762

(22) Filed: Oct. 31, 2017

(51) Int. Cl. H04N 7/18; H04N 5/33; H04N 5/232; H04N 5/91

(52) U.S. Cl. CPC H04N 7/188; H04N 5/91; H04N 5/23241; H04N 5/33

(57) ABSTRACT

Various wall-mounted cameras are disclosed that have embedded computer systems that functionally link the camera to various electronic devices, such as switches, lights, passive infra-red devices, and remote computer systems. The wall-mounted camera could be triggered by passive infra-red devices, which cause the camera to record video streams and transmit them to remote computer systems for analysis and triggering of alternative systems.

### FIELD OF THE INVENTION

The field of the invention is network cameras.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Systems to automatically trigger electronic device commands in response to an outside stimulus are well-known in the art. For example, traditional outdoor security lights use infra-red (IR) sensors to activate a light when it detects an entity above a certain core temperature. Such systems, however, are typically wired separately from standard home systems and are therefore not easy to mount without invasive wiring.

U.S. Pat. No. 4,982,176 to Schwarz teaches a solar-powered outdoor lighting and alarm system that uses a passive IR sensor in conjunction with a battery that does not need to be physically integrated into a housing electronic framework. Schwarz's system, however, simplistically provides mere binary on/off responses to detection of a heat stimulus, and fails to provide more nuanced responses to detected stimuli.

US 2007/0180482 to Frink teaches a battery-powered remote imaging system that activates a camera when a motion sensor detects motion. Frick's system includes a solar panel that can recharge the batteries of the system. Frink's system, however, transmits its images via a wireless cellular modem, which requires a great deal of resources to both maintain and remain connected to at all times.

US 2012/0271477 to Okubo also teaches a solar-powered system that uses an IP camera to monitor systems, such as an ATM system, which activates a light and a camera when a user opens a door leading to an ATM booth. Okubo's system, however, only triggers the system when a human interacts with a physical object, and cannot automatically activate the light and camera without direct human interaction with Okubo's sensors.

US 2016/0173827 to Dannan teaches a solar-powered system that uses a plurality of sensors, such as still image cameras, light sensors, vibration sensors, sound sensors, or even health sensors could be used to trigger some external system. However, using a system with a plurality of Dannan's sensors is rather costly both in financial terms and in terms of power requirements. In addition, Dannan's system fails to integrate easily with existing housing infrastructures, requiring a large amount of time resources to install into an existing home.

Thus, there remains a need for improved triggering systems that optimize installation time, financial cost, and power requirements.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems, and methods in which internet protocol (IP) camera-based security systems are optimized. As used herein, an “IP” camera comprises any camera capable of transmitting video data (e.g. a video stream or a video clip) to another computer system via an electronic network. While such IP cameras could transmit video data via a wired connection, such as an Ethernet or power line communication, contemplated IP camera preferably communicate over a wireless connection, such as wifi or RF, to transmit the video data to a remote computer system.

In some embodiments, a wall-mount switch has an embedded camera and an embedded wall-mount computer system that transmits one or more predetermined commands to an electronic device as a function of data received by the embedded sensor. As used herein, an “embedded” device comprises a device that is encased within a single unit, for example as a single unit for installation into a recess of a wall (e.g. a light-switch recess) or encased within a single housing. Preferably, all of the devices are embedded within a single housing that can be easily installed in an existing wall switch recess to minimize installation time of the wall-mount triggering system. As used herein, a “wall-mounted” system is designed to mount to a recess within a wall, for example a wall switch recess or an in-wall cam. Other IP camera embodiments could be designed to couple to an exterior portion of a wall, but such embodiments are not considered “wall-mounted” unless mounted within a recess.

The embedded wall-mount computer system could comprise an outdoor embodiment that is solar-powered is configured to be mounted to any exterior wall via a mating system (e.g. suction cups for glass walls, screws for wooden walls, frames for outdoor cams). Such embodiments are generally solely powered by a rechargeable battery that is solar powered, and utilize low-power wireless transciever to transmit captured video to a remote computer system. An indoor embodiment is generally powered by the indoor power supply that runs through the wall to an electronic device, such as a lighting system, a wall-plug, or another household device. Such indoor embodiments do not need to utilize low-power wireless transmitters. Both the outdoor embodiment and the indoor embodiment are preferably programmed to transmit commands to the electronic device (e.g. a light) in response to data captured by the camera, which are set by an admin user.

The wall-mount could be configured to continuously record video using the IP camera, analyze video that is recorded by the camera, and send commands to an electronic device when the analysis detects a given event. Such an analysis is preferably performed within a computer processor embedded in the integrated wall-mount unit, but could be performed by a remote security computer system that receives the video stream, or video clip. In some embodiments, the integrated wall-mount unit could analyze the video data to determine whether the video contains a human, and could then trigger a mechanism to record a segment of video when that human entity is detected. The system could only trigger a device when the analyzed human is within a threshold size (e.g. between 4 ft. and 5 ft.), and could even specifically recognize humans using facial recognition software, clothing recognition software, or even a heartbeat pulse of the human (in such embodiments, the integrated wall-mount unit has a heartbeat sensor, such as an audio or laser microphone).

When the integrated wall-mount unit detects a triggering event, the wall-mount unit could trigger a remote device, such as a light switch or a video recording that is transmitted to a user's mobile device. In some embodiments, the integrated wall-mount unit could be programmed to have different modes. For example, during designated daytime hours, the integrated wall-mount unit could be programmed to record one or more video clips of detected humans that are detected within a video stream of the camera, and to transmit alerts of those video clips to a remote user. During designated evening hours, the integrated wall-mount unit could be programmed to automatically activate a light when a human of a certain type (e.g. human above 3 ft tall) is detected and dim the light when that human travels a distance away from the camera.

In some embodiments, the IP camera-based security system comprises a solar-powered IP camera, which is powered via a solar-powered battery that is recharged via a solar panel. In preferred embodiments, the system provides a wired connection port that allows a user to quick-charge the solar-powered battery in emergency situations when the solar panel malfunctions or during long periods when direct sunlight is not available to the solar panel.

Such solar-powered IP cameras systems are preferably constructed as self-contained units to allow for maximum portability and functionality, where each electronic device in the self-contained unit is powered by the solar-powered battery (or batteries). Each solar-powered IP camera system generally comprises a camera programmed to remain in sleep mode until triggered by an electronic device and a low-power wireless transmitter programmed to transmit the video data to a remote computer system.

Contemplated triggers that activate the camera include a passive infra-red (PIR) motion sensor that detects an infra-red motion within an area in front of the motion sensor, a timer that detects a threshold time passed, a pressure plate trigger that detects a threshold weight on the pressure plate (or plates), a temperature sensor that detects a minimum threshold temperature change, or a microphone that detects a signature sound. In embodiments where the trigger comprises a PIR motion sensor, the motion sensor could be configured to only transmit a trigger signal when the infra-red motion exceeds a threshold speed (e.g. 3 mph), or the body performing the infra-red motion exceeds a threshold size (e.g. over 10% of the area being monitored).

When the camera receives a trigger, the system will wake the camera from sleep mode and activate it so that it records video. The video recording could be streamed directly from the camera by also waking up the low-power wireless transmitter and transmitting the video live, but is preferably first saved onto a volatile or non-volatile computer readable medium, such as RAM or SSD, and is then transferred via the low-power wireless transmitter to minimize the time when the low-power wireless transmitter is active. The camera is preferably programmed to only record short videos, for example 5, 10, or 30 seconds long, and also preferably records the short video in a compressed format, also to minimize the length of time when the low-power wireless transmitter is active and transmitting to the remote security computer system. In some embodiments, the camera may be programmed to automatically move its field of vision to track an object. For example, where a PIR motion sensor detects an infra-red motion, the camera may be programmed to automatically track a center of the infra-red motion while recording the video. In other embodiments, a fisheye lens could be coupled to the camera lens or integrated into the camera lens to allow for a wider angle, such as a 180 degree or greater line of sight, which obviates the need to move the camera.

In some embodiments, the trigger may activate other devices integrated with the IP camera unit or functionally coupled with the IP camera unit. For example, when a trigger is received, the IP camera could activate an electronic light source, such as an LED, which is also powered by the solar-powered battery, or could transmit a signal to a network-connected light source or to a physically coupled light source (e.g. via a light switch) to activate the light source.

Contemplated low-power wireless transmitters include low-power wifi devices that consume little power while in sleep mode. As used herein, a “sleep mode” comprises a mode where the full hardware functionality of the device is deactivated to minimize power drain. For example, a wifi device may have a sleep mode that deactivates a transmitter of the wifi device while the receiver of the wifi device may be active. In some embodiments the “sleep mode” may comprise a complete deactivation of the wifi device with a charged capacitor coupled to a switch that is ready to discharge current into the wifi device (or camera) when a wake-up signal is transmitted to the low-power wireless transmitter.

The remote security computer system could comprise any suitable computer system having a processor and a computer-readable medium upon which video data and computer code could be stored, for example a central server, a distributed computer system on a cloud, or a remote mobile device coupled to the IP camera via a network. In some embodiments, where the IP camera communicates with a central server or a cloud, a remote device may communicate to the IP camera via the central server, which relays commands and videos, and acts as a central repository to store historical trend data and videos recorded. Preferably, an admin user interface allows a user to remotely control the IP camera and alter settings of the IP camera, for example setting thresholds for trigger activation, length of time for a video, direction that the camera is pointed, activating a live-feed, etc. With such embodiments, a user may receive a short video from an IP camera that was woken up from sleep mode by a detected motion, watch the short video, and remotely activate a live-feed of the camera from the remote user interface.

In some embodiments, the remote security computer system or a processor integrated within the IP camera unit itself, could be programmed to analyze the video to generate metadata regarding the video. For example, the system could analyze the short video to determine if the entity in the video is a human or an animal. If the system detects that the short video contains a human, a first alert could be triggered (e.g. a text-message to a user's phone and an activation of a live-stream). If the system detects that the short video contains an animal, a second alert, different from the first alert, could be triggered (e.g. a notification on an app and a link to watch the video).

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 comprises a hardware schematic of an internal wall-powered, wall-mounted switch system.

FIG. 2 comprises a hardware schematic of an external solar-powered, wall-mounted outdoor switch system.

FIG. 3 shows an alternative external wall-mount switch system comprising a doorbell.

FIG. 4 comprises a hardware schematic of an external wall-powered, wall-mounted outdoor security system.

FIG. 5 shows an alternative outdoor security system with externally-mounted wall-powered lighting.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Two electronic devices that are “functionally coupled to” one another are coupled in a manner to allow data to pass from one electronic device to another electronic device via any wired or wireless means via any number of intermediary devices.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Computer software that is “programmed” with instructions is developed, compiled, and saved to a computer-readable non-transitory medium specifically to accomplish the tasks and functions set forth by the disclosure when executed by a computer processor.

The inventive subject matter provides apparatus, systems, and methods in which.

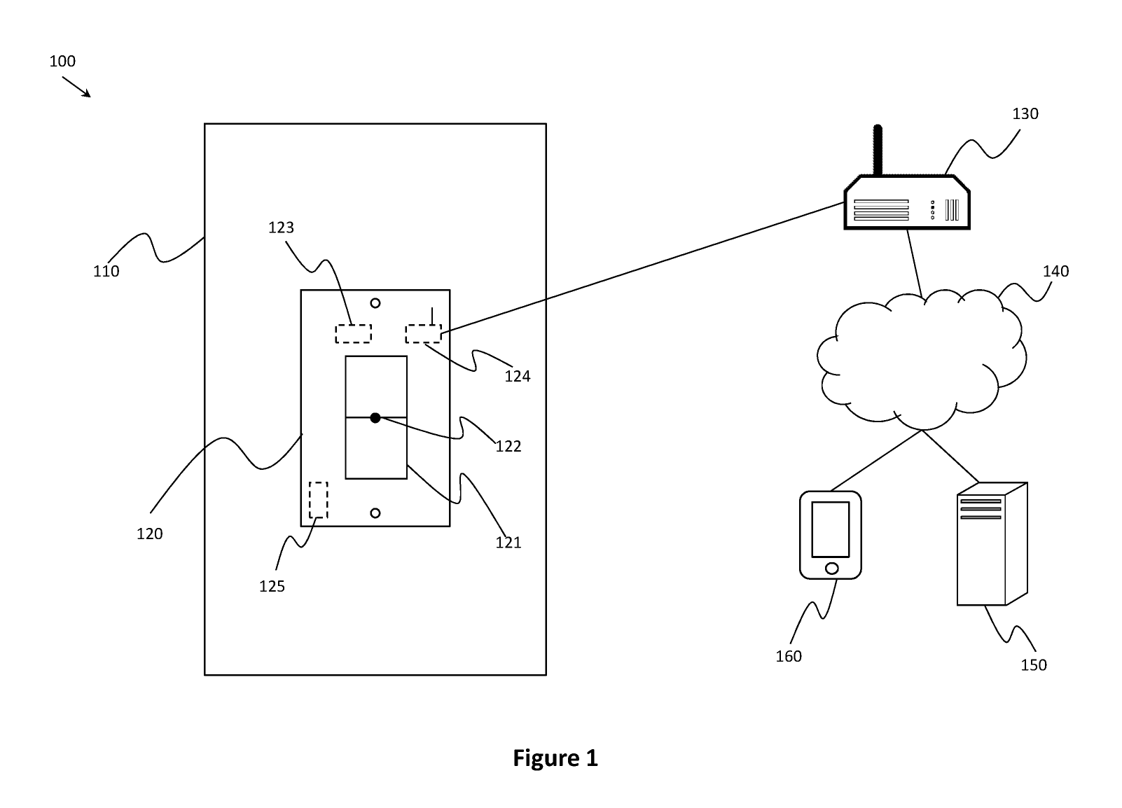

In FIG. 1, an internal wall-mount switch system 100 comprises a wall-mount 120 mounted within a recess of a wall 110. Wall 110 is shown as a substantially flat wall having a standard recess for a wall-mounted switch, but could be any recess in a wall that at least a portion of wall-mount switch system 120 could be mounted within. Exemplary wall recesses include wall cams and wall plugs. Preferably, the wall recess could comprise an electrical connection (not shown) that provides power to wall-mount 120. Generally, such electrical connections also comprise a circuit to an electronic device (not shown), such as a light or a fan, such that a first configuration of switch 122 activates the electronic device, and a second configuration of switch 122 deactivates the electronic device.

Wall-mount 120 comprises switch 121, camera 122, computer system 123, wireless transceiver 124, and power transformer 125. Switch 121 is shown euphemistically as a binary switch having two configurations, a switch-up configuration where the upper portion of the switch is depressed and a circuit is closed between the switch and an electronic device coupled to the switch, and a switch-down configuration were the lower portion of the switch is depressed and a circuit is open between the switch and the electronic device. Other switches could be used, for example switches with buttons or touchpad areas, but preferably the switch is a binary switch with only two configurations, on and off, that activate or deactivate the electronic device which the switch is coupled to. While the electronic device could be functionally coupled to the switch via an indirect means (e.g. a wireless network connection), the electronic device is preferably directly coupled to the switch in a manner that opens or closes a circuit to the electronic device when a user moves the switch from a first configuration to a second configuration, or vice-versa.

Camera 122 is shown euphemistically as a single lens embedded within switch 121 itself, but could be embedded in other areas of wall-mount 120 in other configurations. Preferably, camera 122 records at all times, particularly where wall-mount 120 is coupled to a stable power source, such as a wire in a building wall supplied by a power company, as opposed to a wire that supplies power from a battery that must be periodically recharged. Any sort of camera capable of transmitting or saving streams of images is contemplated. Preferably, the camera has a fisheye lens capable of filming at least 120 degrees, 150 degrees, or 180 degrees of visibility from the lens so that the camera direction need not move in order to record an object in front of the lens.

Power transformer 125 couples to the stable power source (not shown) and provides power to each of switch 121, camera 122, wall-mount computer system 123, and wireless transceiver 124. Preferably, power transformer 125 provides such power in parallel such that camera 122 does not lose power if a circuit within switch 121 is open. Such a parallel connection is important in embodiments where switch 121 is in a serial power pathway between a power source and an electronic device controlled by switch 121.

Wireless transceiver 124 comprises a WiFi router that bridges wall-mount computer system 123 with remote computer systems, such as server 150 or hand-held computer system 160. While wall-mount 120 could use a wired transceiver, such as an Ethernet transceiver or an Internet over powerline transceiver, a WiFi transceiver is preferred as such systems tend to be ubiquitous in homes, and tend to require less setup and maintenance than wired transceivers, or wireless transceivers using other protocols. Wireless transceiver 124 is functionally coupled to home router 130, which connects to Internet 140. Each of wireless transceiver 124, wireless router 130, and Internet network 140 act as a network gateway to allow communication between wall-mount computer system 123 and server 150, and between server 150 and mobile computer system 123. While it is contemplated that mobile computer system 160 could communicate directly with wall-mount computer system 123 via any electronic protocol, such as Ethernet, Bluetooth, Infrared, RF communication, and WiFi routers, preferred embodiments have a client-server relationship, where wall-mount computer system 123 and mobile computer system 160 are programmed to be clients of server 150, allowing server 150 to act as a central repository for profiles, saved videos, etc. With such a configuration, mobile computer system 160 could be replaced easily with another mobile computer system, or wall-mount 120 could be replaced easily with another wall-mount system, while incurring minimal data loss.

Wall-mount computer system 123 is functionally coupled to power transceiver 125, camera 122, and wifi transceiver 124, and transmits triggers when threshold events are detected by camera 122. For example, in one embodiment an admin user could set a “day mode” where camera 122 monitors activity during the daytime (when owners are out of the house), and detects a human being signature within its view. When nobody is supposed to be in the house, wall-mount computer system could record a video, for example a 10 second video snippet, or a video from the beginning of when wall-mount computer system 123 detects a human signature from camera 122 to the end of when wall-mount computer system 123 detects a human signature from camera 122. The same admin user could also set a “night mode” where camera 122 monitors activity during the evening (when owners are in the house), and could dim lights or completely shut off lights when wall-mount computer system 123 detects a human signature walking away from camera 122 or completely leaving the field of vision of camera 122.

Wall-mount computer system 123 is preferably configured with software that recognizes visual signatures, particularly of visual signatures of moving 3-D objects, such as animals and humans. In some embodiments, an admin user could set wall-mount computer system 123 to recognize types of animals or types of humans, such as dogs, cats, adults, children, or people with hats. In other embodiments, an admin user could set wall-mount computer system to recognize specific animals or specific humans, for example by first recognizing the silhouette of a human, and then by recognizing clothes that the human is wearing, or by performing facial recognition. An admin user could then transmit various sets of commands in response to detected types of humans/animals or to detected specific humans/animals.

In some embodiments, server 150 could be configured to administer to a plurality of similar wall-mount systems within a home, allowing the various wall-mount computer systems to record short snippets of activity detected by camera 122. In some embodiments wall-mount computer system 123 could have an AI (artificial intelligence) module that controls both indoor lighting and an internal surveillance system as needed.

While wall-mount 120 is shown as mounted within a recess of wall 110, wall-mount 120 could be mounted to an exterior surface of wall 110 in some embodiments. Wall-mount 120 could be coupled to the exterior surface via any suitable manner, for example via cement, tape, screws, via a mechanical mating between an exterior male/female connector, or via a slot.

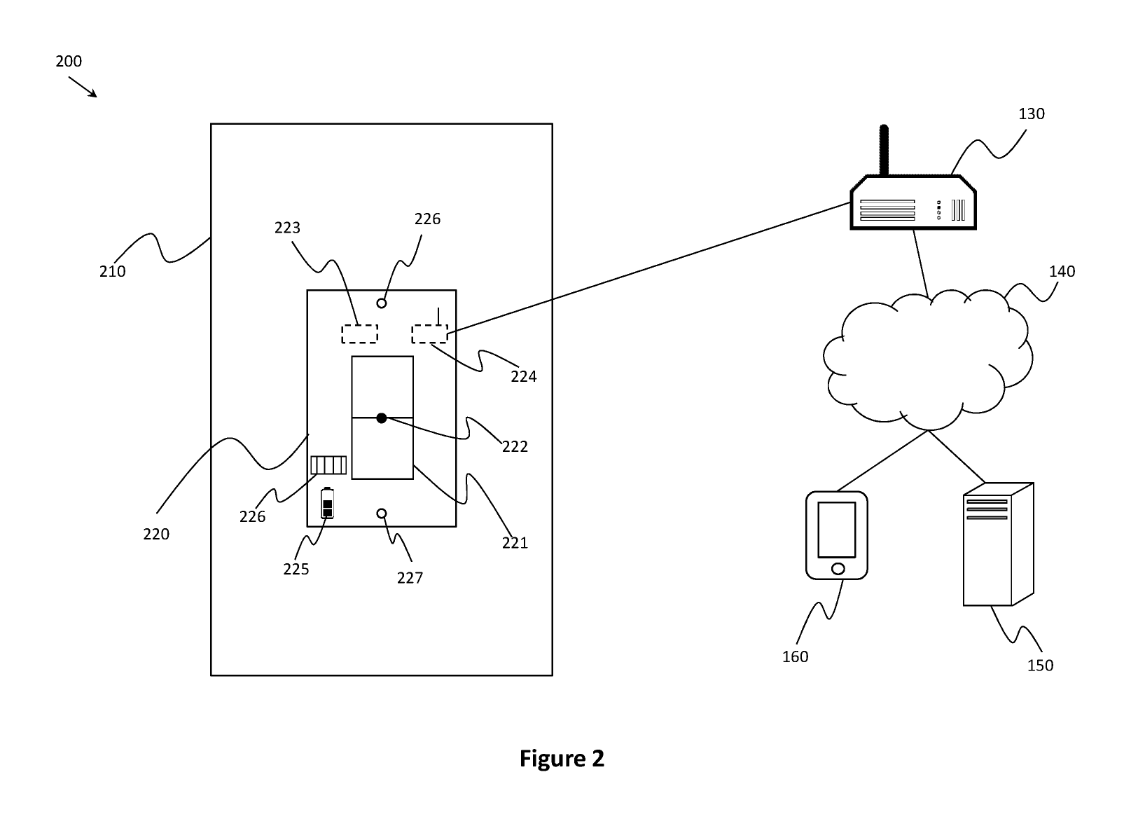

In FIG. 2, an external wall-mount switch system 200 comprises a wall-mount 220 mounted within a recess of a wall 210. Wall 210 is similar to wall 110, however wall 210 does not have a recess comprising a power source from which a power transformer can power the entire wall-mount 220. Wall-mount 220 is powered by rechargeable battery 225, which is recharged via solar panel 226. Rechargeable battery 225 provides power to each of switch 221, camera 222, wall-mount computer system 223, and wireless transceiver 224. Wireless transceiver 224 is preferably a low-power wireless transceiver that only fully activates when video is being sent from wall-mount computer system 223, or is being received by wall-mount computer system 223, so as to minimize power consumption of wall-mount 220.

In other embodiments, wall-mount 120 could be battery-powered with a rechargeable battery (not shown) and the rechargeable battery 225 is preferably a lithium ion battery that can be quick-charged via screw terminals 226 and 227 in situations where battery drain exceeds the rate at which rechargeable battery 225 is charged by solar panel 226. Screw terminals 226 and 227 are shown as screws that also act as electronic terminals that could be utilized to quick-charge rechargeable battery 225. In other embodiments, rechargeable battery 225 could be recharged via a USB port (not shown) or some other coupling that allows power to be used to charge rechargeable battery 225.

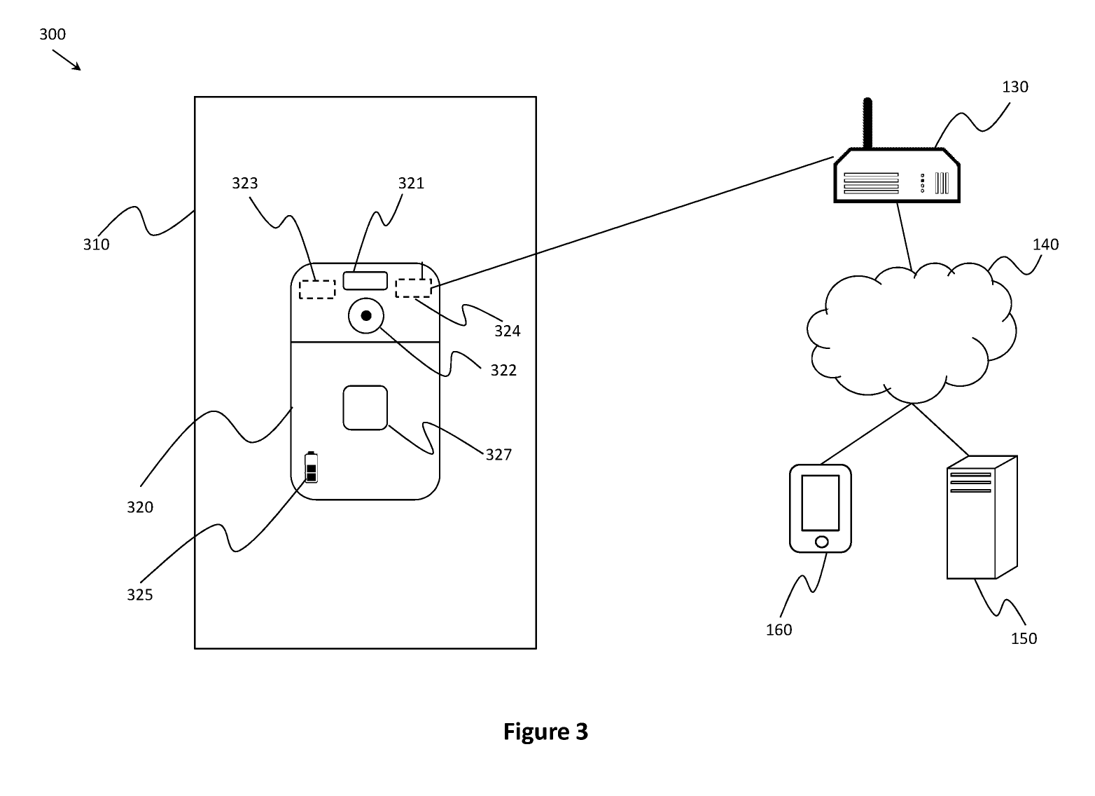

FIG. 3 shows another external wall-mount switch system 300 that comprises a wall-mount front doorbell 320 coupled to a wall 310. The wall-mount front doorbell 320 is powered by rechargeable or replaceable battery 325, which saves power similar to wall-mount switch system 200 by placing both camera 322 and wireless transmitter 324 in power off mode or in sleep mode unless a trigger is received, either by PIR sensor 321 and/or by doorbell 327. The trigger can be sent to computer system 323, which then activates camera 322, to capture a stream of video. The stream of video could be of a predefined length (e.g. 10 or 20 seconds), or could be captured until a termination trigger (e.g. the heat sensed by the PIR sensor drops below the predetermined threshold amount). Computer system 323 could save each snippet of video to a local computer-readable medium, but preferably streams the snipped to computer system 150 via router 130 for storage, which could then be accessed by mobile device 160. In preferred embodiments, a user utilizing remote phone system 160 could view the snippet of video and trigger another action, for example by unlocking the door remotely via another system (not shown) using mobile device 160.

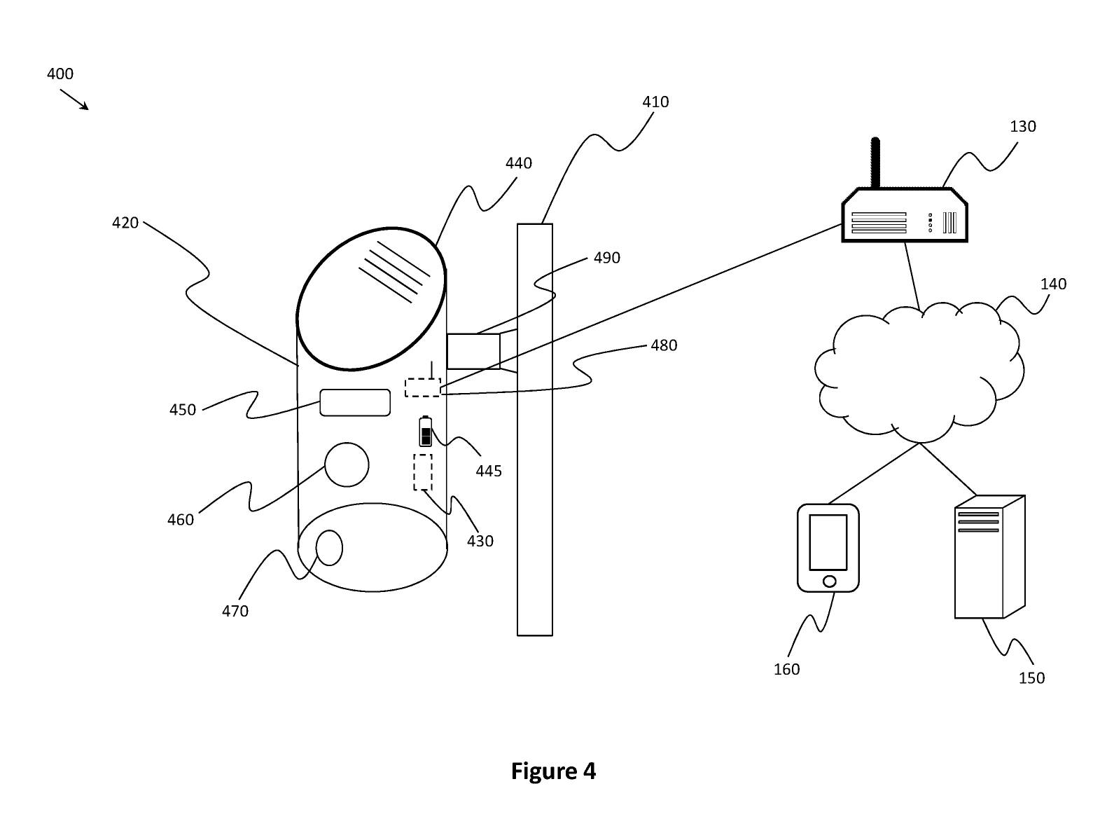

In FIG. 4, an external IPC camera system 400 has an IPC camera 470 coupled to wireless router 130 via wireless transceiver 480. IPC camera 470 lacks the switches of systems 100 and 200, and is preferably optimized to act as a security system that could be easily placed anywhere about a home—mounted to wall 410 via wall mount bracket 490. Since IPC camera 470 also utilizes a battery 445 recharged by solar panel 440 as its power source, IPC camera 470 is preferably placed in any location where a sufficient amount of sunlight hits solar power 440.

Video camera 470 is preferably dormant until PIR sensor 450 detects a heat signature, or a signature that satisfies a threshold value (minimum, maximum, or both). Since PR sensor 450 consumes much less power to operate than video camera 470, IPC computer system 430 preferably monitors sensed data from PR sensor 450 and only activates camera 470 for a period of time necessary to capture a video of interest. In some embodiments, an admin user could set up IPC computer system 430 to deactivate camera 470 and wireless transmitter 480 until needed, and could wake up camera 470 when a threshold heat signature is detected by PIR sensor 450. Here, video camera 470 is mounted to a swivel system that allows the video camera 470 to automatically follow a heat signature of a minimum defined threshold value while recording (or between a minimum and a maximum defined threshold value), or allows a remote user to move the camera during recording.

In some embodiments, computer system 430 will trigger the use of light 460 while recording with video camera 470 to allow for better images to be captured. In some embodiments, light 460 will illuminate when a first threshold of heat is detected by PIR sensor 450, and camera 470 will only activate when a second threshold of heat, greater than the first threshold of heat, is detected by PIR sensor 450. Likewise, when the detected heat drops below the second threshold of heat, camera 470 could stop recording, and when the detected heat drops below the first threshold of heat, light 460 could be deactivated by computer system 430.

Furthermore, IPC computer system 430 could store snippets of videos on a local computer-readable medium, and could then transmit such video snippets to server 150 and/or mobile computer system 160 in response to a command, for example in response to a command to transmit periodic snippets of captured video snippets, or a command received from mobile computer system 160.

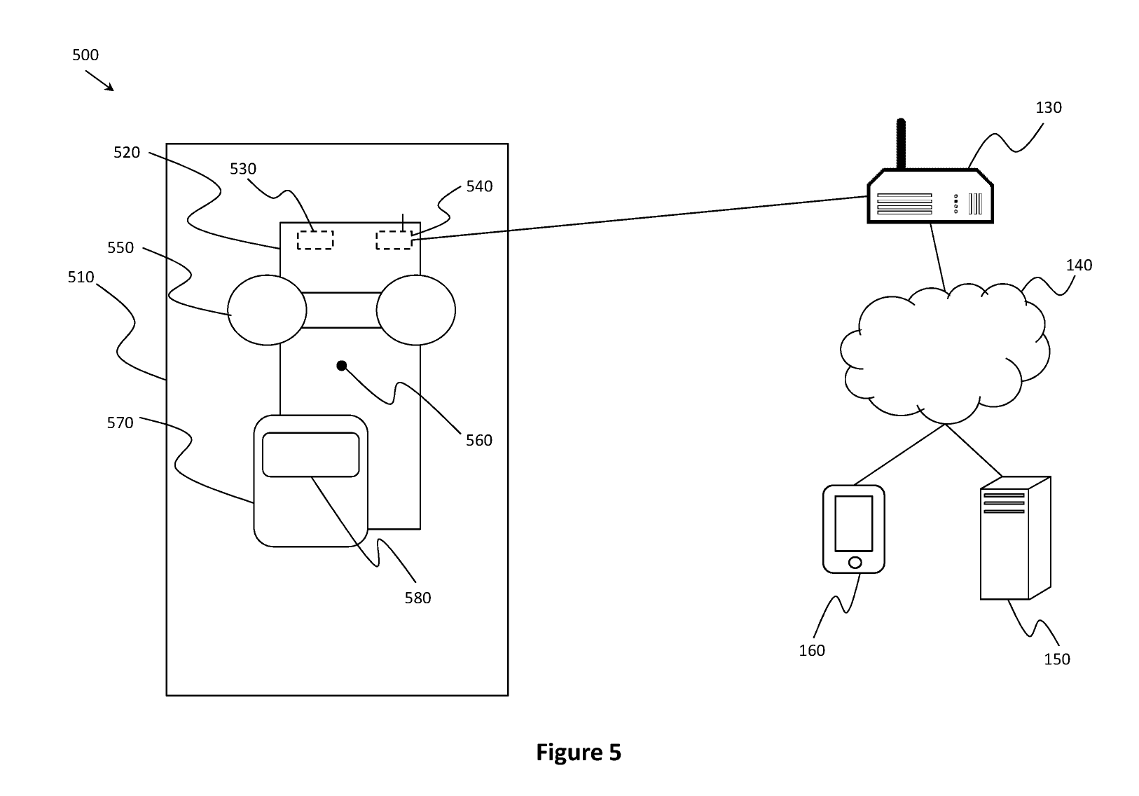

In FIG. 5, an outdoor security system 500 comprises an externally-mounted wall-powered lighting and IPC apparatus 520 is wall-mounted on wall 510, which provides a power-source to apparatus 520. Apparatus 520 comprises a PIR sensor 580 mounted on arm 570 that can be rotatably directed to monitor a specific area for a heat signature. When the heat signature detected by PIR sensor 580 exceeds a threshold level, light 550 could activate and/or camera 560 could start recording. Like camera system 400, light 550 and camera 560 could be activated/deactivated in accordance with different thresholds. Video streams could be transmitted using transceiver 540, and the functionality of apparatus 520 could be controlled by computer system 530.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A wall-mount, comprising:
an embedded switch having a first configuration that activates an electronic device and a second configuration that deactivates the electronic device;
an embedded camera disposed to monitor an area about the wall-mount; and
an embedded wall-mount computer system functionally coupled to the switch, the camera, and the electronic device, wherein the wall-mount computer system comprises electronic instructions to transmit a set of predetermined commands to the electronic device as a function of data received by the camera.

2. The wall-mount of claim 1, wherein the switch, the camera, and the computer system are embedded within a single housing that mates with a wall-switch recess.

3. The wall-mount of claim 2, wherein the wall-switch recess comprises a wired power connection that couples to a power transformer of the wall-mount to supply power to the camera and the wall-mount computer system.

4. The wall-mount of claim 1, wherein the video camera streams image data to the wall-mount computer system.

5. The wall-mount of claim 6, wherein the electronic instructions further monitor the image data for a visual signature to trigger transmission of the set of predetermined commands.

6. The wall-mount of claim 5, wherein the visual signature comprises at least one of a type of animal, a specific animal, a type of person, and a specific person.

7. The wall-mount of claim 8, wherein the electronic instructions save a video segment to a memory when the visual signature is detected by the video camera.

8. The wall-mount of claim 7, wherein the video segment comprises at most a ten second segment.

9. The wall-mount of claim 8, wherein the electronic instructions transmit the video segment to a remote computer system that saves the video segment to the memory.

10. The wall-mount of claim 9, wherein the remote computer system comprises a remote server.

11. The wall-mount of claim 1, wherein the wall-mount computer system is programmed to have a security recording mode during a first time-period and an electronic-device control mode during a second time-period.

12. The wall-mount of claim 1, further comprising an embedded low-power wireless transmitter programmed to transmit at least some of the data to a security computer system via a network.

13. The wall-mount of claim 12, wherein the low-power wireless transmitter comprises a WiFi transmitter.

14. The wall-mount of claim 1, further comprising a solar panel that provides power to a solar-powered battery that powers the camera, wall-mount computer system, and the low-power wireless transmitter.

15. The wall-mount of claim 1, wherein the electronic device comprises a light source, and wherein the set of predetermined commands comprises a brightness level of the light source.
